(19) United States
(12) Patent Application Publication
(10) Pub. No.: US 2013/0200281 A1
(43) Pub. Date: Aug. 8, 2013

(54) FLOW CONTROL VALVE AND METHOD FOR USING THE SAME

(71) Applicants: Stefan Schuermann, Walldorf (DE); Ali-Akbar Inanloo, Mannheim (DE); Juergen Kreutzkaemper, Berlin (DE)

(72) Inventors: Stefan Schuermann, Walldorf (DE); Ali-Akbar Inanloo, Mannheim (DE); Juergen Kreutzkaemper, Berlin (DE)

(73) Assignee: AKTIEBOLAGET SKF, Goteborg (SE)

(21) Appl. No.: 13/569,716

(22) Filed: Aug. 8, 2012

(30) Foreign Application Priority Data
Aug. 12, 2011 (DE) 10 2011 080 908.2

(51) Int. Cl. F16K 31/12

(52) U.S. Cl. CPC F16K 31/12
USPC 251/12

(57) ABSTRACT

A flow control valve includes at least one inlet unit configured to permit an inflow of a liquid into the flow control valve, and at least one outlet unit configured to permit an outflow of the liquid out of the flow control valve. The inlet unit is at least partially disposed on a radial outer surface of the flow control valve.

### CROSS-REFERENCE

This application claims priority to German patent application no. 10 2011 080 908.2 filed on Aug. 12, 2011, the contents of which are fully incorporated herein by reference.

### TECHNICAL FIELD

The present invention generally relates to flow control valves for fluids, e.g., used in hydraulic or lubrication systems.

### BACKGROUND

Known flow control valves include an inlet valve disposed on one axial end face of the flow control valve and configured to permit a liquid (fluid) to flow into the flow control valve, as well as at least one outlet unit configured to permit the liquid to flow out of an opposite axial end of the flow control valve.

### SUMMARY

It is an object of the present teachings to disclose improved flow control valves and methods of using the same.

Flow control valves according to one aspect of the present teachings preferably include at least one inlet unit configured to permit an inflow of a liquid (fluid) into the flow control valve, and at least one outlet unit configured to permit an outflow of the liquid from the flow control valve.

The inlet unit is preferably provided or disposed at least partially on a radial outer surface of the flow control valve. As used herein, the term “provided” is intended to mean, e.g., “specially designed” and/or “specially equipped”. In addition, the terms “radially” and “radial direction” are intended to mean a direction that extends perpendicular to a straight line, which extends through the center of the flow control valve and parallel to the longitudinal extension direction (i.e. the axial direction) of the flow control valve. A versatile and efficient flow control valve is provided according to this aspect of the present teachings. For example, flexible and/or efficient flow paths of fluids (liquids) inside the flow control valve can be achieved. The flow control valve can be used especially efficiently in devices in which liquid flows toward the flow control valve radially and away from the flow control valve axially. In addition or in the alternative, a compact structure can be achieved.

The inlet unit preferably has at least one through opening extending in the radial direction from an outer side of the flow control valve to an interior region/chamber of the flow control valve. In this case, a structurally simple design of the inlet unit can be achieved.

In addition or in the alternative, the flow control valve preferably has at least one channel extending from the inlet unit to a pressure transfer portion of a control element of the flow control valve. The pressure transfer portion is preferably configured to at least partially load at least one energy storage element of the flow control valve by using (in accordance with) the pressure of the liquid (fluid) that has flowed into the flow valve and that has flowed through the channel. In this case, a simple controlling of the valve is possible. Preferably, the energy storage element is or comprises a compression spring, whereby an inexpensive design can be achieved.

In addition or in the alternative, the channel preferably extends at least partially inside a wall of a sleeve element of the flow control valve. In this case, the required installation space can be reduced. Preferably, the sleeve element is formed from one piece. As used herein, the term “one piece” is intended to mean from a single casting and/or from a singe injection and/or that it can be taken apart only by destroying/damaging it.

In addition or in the alternative, the flow control valve preferably includes at least one adjustment element configured to change/alter/adjust the difference in pressure that exists during operation between the liquid (fluid) at the inlet unit and the liquid at the outlet unit. In this case, flexible modes of operation can be achieved.

Preferably, the outlet unit is farther away (more distant) from the adjustment element than the inlet unit. In this case, a versatile flow control valve can be achieved. For example, the flow control valve could be incorporated into a housing, which includes a supply line is connected to the incorporated flow control valve and lies near a surface of the housing.

The adjustment element may preferably have at least two control contours, which determine the pressure difference in accordance with (in dependence upon or in proportion to) the location of the adjustment element relative to the inlet unit along the axial direction of the flow control valve. In this case, the outflow cross-section of the outlet unit can be influenced/changed/altered by changing the location (distance) of the adjustment element relative to the inlet unit.

In addition or in the alternative, the flow control valve preferably includes an actuator unit (element) which is manually displaceable along the longitudinal extension direction of the flow control valve, and which actuates the adjustment unit (element) by effecting such a displacement. In this case, the behavior and/or the flow-through ratio of the flow control valve can be adjusted.

In another aspect of the present teachings, a device may include a flow control valve according to any preceding or following design or embodiment. The device preferably further has a channel that extends (or is defined) outside the flow control valve and extends in the radial direction towards at least one inlet opening of the inlet unit. In this case, the inflow of the liquid into the flow control valve can be achieved in a simple manner.

The channel extending (defined) outside the flow control valve preferably extends, starting from the outlet unit, away from the flow control valve, along the longitudinal extension direction of the flow control valve. In this case, a compact structure can be achieved.

Further objects, embodiments, advantages and designs of the present teachings will be explained in the following, or will become apparent, with the assistance of the exemplary embodiments and the appended Figures.

### BRIEF DESCRIPTION OF THE DRAWINGS

FIG. 1 shows a partial cross-sectional view a device having a representative flow control valve according to the present teachings.

FIG. 2 shows a plan view from above of a part of an adjustment element of the flow control valve.

### DETAILED DESCRIPTION OF THE INVENTION

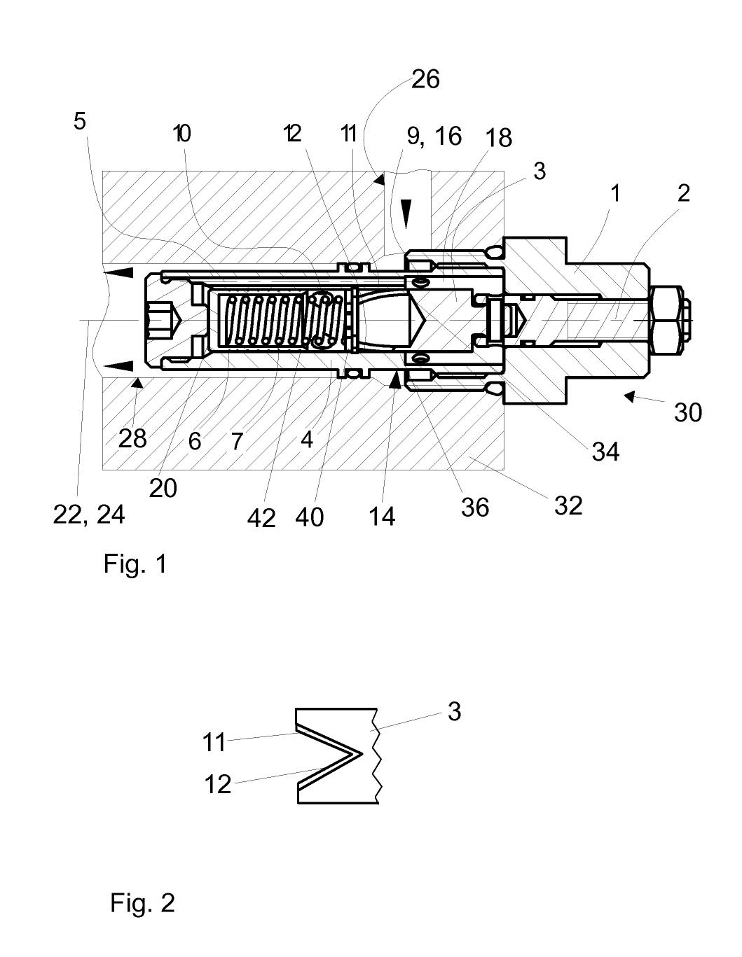

FIG. 1 shows a partial cross-sectional of an engine block that includes a flow control valve 30 according to the present teachings. In the alternative, the device can instead be a control block. Of course, the present flow control valves are not limited to these applications and can be utilized in a wide variety of fields.

As shown in FIG. 1, the flow control valve 30 is screwed into a housing 32. The housing 32 has a first channel 26 and a second channel 28. During operation, hydraulic oil flows through the first channel 26, the flow control valve 30 and then the second channel 28. However, in an alternative embodiment, lubrication oil may be used instead of the hydraulic oil. Of course, other types of fluids also may be advantageously utilized with the present flow control valves.

The hydraulic oil flows through the first channel 26 to an inlet unit 9 of the flow control valve 30 and then into an interior chamber 18 of a valve body of the flow control valve 30. After the hydraulic oil has passed through the flow control valve 30, it flows through an outlet unit 10 out of the flow control valve 30 and into the second channel 28.

The inlet unit 9 is disposed on a radial outer surface 14 of the flow control valve 30. A sleeve element 4 forms a part of the radial outer surface 14 of the inlet unit 9 and has a through opening 16. The through opening 16 extends in the radial direction with respect to a longitudinal extension direction 24 of the flow control valve 30, starting from the outer surface 14, to the interior chamber 18 of the flow control valve 30. The first channel 26 extends to the through opening 16 in the radial direction with respect to the longitudinal extension direction 24. Additional through openings (16) of the inlet unit 9, which are identical to the through opening 16, may be uniformly distributed around the circumference of the outer surface of the inlet unit 9 (sleeve element 4).

An adjustment element 3 of the flow control valve 30 is formed as a throttle piston (pin) and is configured to change the pressure difference existing during operation between the hydraulic oil at the inlet unit 9 and the hydraulic oil at the outlet unit 10.

That is, the hydraulic oil flows through a gap on its way from the inlet unit 9 to the outlet unit 10. The gap is formed or defined by portions 34, 36 of the sleeve element 4, by portions of the adjustment element (throttle piston/pin) 3, and by control contours 11, 12 of the adjustment element 3. As viewed in the direction towards the control contours 11, 12 along the longitudinal extension direction of the first channel 26 (FIG. 2), the control contour 11 differs from a half of a hollow cylinder by a triangle-shaped opening. The control contour 12 also differs in the same view (FIG. 2) from a half of a hollow cylinder by a triangle-shaped opening, but the last-mentioned opening is smaller than the first-mentioned opening. The pressure of the hydraulic oil after it has flowed through the gap is less than the pressure of the hydraulic oil within the interior region 18. After flowing through the gap, the oil flows further to the outlet unit 10 without loss of pressure.

A component 1 of the flow control valve 30 is screwed into the housing 32. In addition, an actuator element 2 is formed as a spindle (pin) and is screwed into the component 1. By (e.g., manually) rotating the actuator element 2 about the longitudinal extension direction 24 (i.e. about the axial direction of the flow control valve 30), the actuator element 2 is displaceable along the longitudinal extension direction 24. By displacing (moving) the adjustment element 3 along (in) the longitudinal extension direction 24, the cross-section of the gap is changed, which gap is bounded by the control contours 11, 12 and by the portions 34, 36. Therefore, the pressure decrease, which the hydraulic oil experiences when flowing through this gap, can be changed by displacing/moving the actuating element 2 in the longitudinal/axial direction.

The flow control valve 30 also includes a control element 6 formed as a control piston. The control element 6 is disposed in the interior region/chamber of the sleeve element 4 and is disposed so as to be movable along (in) the axial direction 22. The control element 6 can be moved to a position or location such that no oil can flow between the sleeve element 4 and the control element 6.

An energy storage element 7 of the flow control valve 30 comprises or is formed as a compression spring that abuts on a perforated disk 40, which is fastened to the sleeve element 4. The perforated disk 40 presses against a pressure transfer portion 20 of the control element 6.

The outlet unit 10 has one or more through openings, which lead from the interior region/chamber of the sleeve element 4 into the second channel 28. A channel 5 guides oil from the interior region/chamber without loss of pressure to the pressure transfer portion 20, so that the oil in question presses against the pressure transfer portion 20 and compresses the compression spring 7.

The channel 5 extends inside or within a wall of the sleeve element 4 along the axial direction 22. By displacing it along the direction 24, a hollow-cylinder-shaped end portion 42 of the control element 6 closes the outlet unit 10 at least partially and thereby restricts the oil flow volume that can flow out through the outlet unit 10. The second channel 28 guides the oil, starting from the outlet unit 10, along the longitudinal extension direction 24, away from the flow control valve 30.

A force, which is caused (generated) by the oil that flows through the channel 5, acts on the control element 6. Therefore, the spring force of the compression spring and the force of the oil flowing through the gap (disposed between the compression spring 7 and the outlet unit 10) both act on the control element 6. As a result, the control element 6 will move to a position or location where these two forces are balanced or equalized. This position can be influenced by actuation (displacement) of the actuator element 2 along the axial direction 22. That is, by actuating (moving) the actuator element 2, a different adjustment behavior with respect to a pressure difference change is provided by the different control contours 11, 12 along the direction 22. That is, the amount of the pressure drop across the above-described gap can be altered by moving (displacing) the actuating element 2 in the axial direction 22.

A perforated securing ring is disposed near the disk 40 and secures the disk 40.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved flow control valves and methods for manufacturing and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

| | |
|---|---|
| 1 | Component |
| 2 | Actuator unit |
| 3 | Adjustment element |
| 4 | Sleeve element |
| 5 | Channel |
| 6 | Control element |
| 7 | Energy storage element |
| 9 | Inlet unit |
| 10 | Outlet unit |
| 11 | Control contour |
| 12 | Control contour |
| 14 | Outer surface |
| 16 | Through opening |
| 18 | Interior chamber |
| 20 | Pressure transfer portion |
| 22 | Direction |
| 24 | Longitudinal extension |
| | direction |
| 26 | Channel |
| 28 | Channel |
| 30 | Flow control valve |
| 32 | Housing |
| 34 | Portion |
| 36 | Portion |
| 40 | Disk |
| 42 | End portion |

1. A flow control valve comprising:
at least one inlet unit configured to permit an inflow of a liquid into the flow control valve, and
at least one outlet unit configured to permit an outflow of the liquid out of the flow control valve,
wherein the inlet unit is at least partially disposed on a radial outer surface of the flow control valve.

2. The flow control valve according to claim 1, wherein the inlet unit has at least one through opening extending in a radial direction from an outer side of the flow control valve to an interior chamber of the flow control valve.

3. The flow control valve according to claim 2, further including:
a control element having a pressure transfer portion,
at least one channel extending from the inlet unit to the pressure transfer portion, and
at least one energy storage element that is loadable by the pressure transfer portion in accordance with changes in pressure of the liquid that has flowed into the flow control valve and though the channel.

4. The flow control valve according to claim 3, further comprising a sleeve element having a wall defining at least a portion of the channel.

5. The flow control valve according to claim 4, further comprising at least one adjustment element configured to change a pressure difference existing during operation between liquid at the inlet unit and liquid at the outlet unit.

6. The flow control valve according to claim 5, wherein the outlet unit is disposed farther away from the adjustment element than the inlet unit.

7. The flow control valve according to claim 6, wherein the adjustment element has at least two control contours configured to determine the pressure difference in proportion to the location of the adjustment element relative to the inlet unit along an axial direction of the flow control valve.

8. The flow control valve according to claim 7, further comprising an actuator element that is manually displaceable along the axial direction and is configured to influence the adjustment element by such displacement.

9. The flow control valve according to claim 1, further comprising at least one adjustment element configured to change a pressure difference existing during operation between liquid at the inlet unit and liquid at the outlet unit.

10. The flow control valve according to claim 9, wherein the outlet unit is disposed farther away from the adjustment element than the inlet unit.

11. The flow control valve according to claim 9, wherein the adjustment element has at least two control contours configured to determine the pressure difference in proportion to the location of the adjustment element relative to the inlet unit along an axial direction of the flow control valve.

12. The flow control valve according to claim 9, further comprising an actuator element that is manually displaceable along the axial direction and is configured to influence the adjustment element by such displacement.

13. A device comprising:
the flow control valve according to claim 8,
wherein the device has a channel that extends outside of the flow control valve and extends in the radial direction towards the at least one through opening of the inlet unit.

14. A device comprising:
the flow control valve according to claim 1,
wherein the device has a channel that extends outside of the flow control valve and extends in a radial direction towards at least one through opening of the inlet unit.

15. A method comprising:
flowing liquid in the radial direction through the inlet unit of the flow control valve according to claim 8, and
flowing the liquid in the axial direction out through the outlet unit of the flow control valve.

16. A method comprising:
flowing liquid in a radial direction through the inlet unit of the flow control valve according to claim 1, and
flowing the liquid in an axial direction out through the outlet unit of the flow control valve.

17. A flow control valve comprising:
a valve body at least partially defining an interior chamber of the valve and having a radial direction that is perpendicular to an axial direction,
at least one inlet unit at least partially disposed on a radially outer surface of the valve body and having at least one radially-extending through-hole configured to permit a liquid to flow into the interior chamber of valve body from the radial direction thereof, and
at least one outlet unit configured to permit the liquid to flow out of the interior chamber of the valve body in the axial direction of the valve body.

18. The flow control valve according to claim 17, further comprising:
a control element having a pressure transfer portion,
at least one channel extending from the inlet unit to the pressure transfer portion, and
at least one compression spring abutting the pressure transfer portion and being loadable in accordance with changes in pressure of the liquid that has flowed from the interior chamber of the valve body and though the channel.

19. The flow control valve according to claim 18, further comprising at least one adjustment element configured to change a pressure difference existing during operation between liquid at the inlet unit and liquid at the outlet unit, the adjustment element having at least two control contours configured to determine the pressure difference in proportion to the location of the adjustment element relative to the inlet unit along the axial direction of the valve body.

20. The flow control valve according to claim 19, further comprising a sleeve element surrounding the outlet unit and having a wall defining at least a portion of the channel and the valve body, wherein the radially-extending through-hole is defined in the wall of the sleeve element.
